(19) United States
(12) Patent Application Publication
(10) Pub. No.: US 2016/0066097 A1
(43) Pub. Date: Mar. 3, 2016

(54) ACOUSTIC TRANSDUCER

(71) Applicant: SAMSUNG ELECTRO-MECHANICS CO., LTD., Suwon-si (KR)

(72) Inventors: Hwa Sun LEE, Suwon-si (KR); Jae Chang LEE, Suwon-si (KR); Byung Hun KIM, Suwon-si (KR)

(73) Assignee: SAMSUNG ELECTRO-MECHANICS CO., LTD., Suwon-si (KR)

(21) Appl. No.: 14/626,961

(22) Filed: Feb. 20, 2015

(30) Foreign Application Priority Data
Aug. 28, 2014 (KR) 10-2014-0112999

(51) Int. Cl. H04R 7/16; H04R 1/28

(52) U.S. Cl. CPC H04R 7/16; H04R 1/2892

(57) ABSTRACT

An acoustic transducer includes a substrate member including a first region having one or more first holes formed therein, and a second region, a vibration member including a third region facing the first region and a fourth region facing the second region and having one or more second holes formed therein, and a support member extended from a boundary region between the first region and the second region to a boundary region between the third region and the fourth region to allow the substrate member and the vibration member to be spaced apart from each other by a predetermined interval.

### CROSS-REFERENCE TO RELATED APPLICATION

This application claims the benefit of Korean Patent Application No. 10-2014-0112999 filed on Aug. 28, 2014, with the Korean Intellectual Property Office, the disclosure of which is incorporated herein by reference.

### BACKGROUND

The present disclosure relates to an acoustic transducer capable of decreasing a signal to noise ratio.

An acoustic transducer is an element mounted on a portable terminal, or the like, and converts the pressure of sound waves or acoustic signals into electric signals. Such an acoustic transducer commonly includes a diaphragm configured to be vibrated by the pressure of sound waves.

However, since an acoustic transducer having the above-mentioned structure may be easily vibrated by variable pressure other than the pressure of sound waves, it may be difficult to obtain an acoustic signal from which unnecessary noise has been entirely removed.

As related art associated with the present disclosure, there is provided Patent Document 1.

### RELATED ART DOCUMENT

(Patent Document 1) KR2008-098624 A

### SUMMARY

An aspect of the present disclosure may provide an acoustic transducer capable of improving acoustic sensitivity by decreasing a signal to noise ratio.

According to an aspect of the present disclosure, an acoustic transducer may include a vibration member configured to have different displacements for the same pressure of sound waves.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a cross-sectional view of an acoustic transducer according to an exemplary embodiment in the present disclosure;

FIG. 2 is an enlarged view of the part A illustrated in FIG. 1;

FIG. 3 is an enlarged view of the part B illustrated in FIG. 1;

FIG. 4 is a plan view of the acoustic transducer illustrated in FIG. 1;

FIG. 5 is an enlarged view of the part C illustrated in FIG. 4;

FIG. 6 is a view illustrating another form of the part C illustrated in FIG. 5;

FIG. 7 is a view illustrating another form of the part C illustrated in FIG. 5;

FIGS. 8 and 9 are views illustrating an operation state of the acoustic transducer illustrated in FIG. 1;

FIG. 10 is a cross-sectional view of an acoustic transducer according to another exemplary embodiment in the present disclosure;

FIG. 11 is a view illustrating another form of the acoustic transducer illustrated in FIG. 10;

FIG. 12 is a cross-sectional view of an acoustic transducer according to another exemplary embodiment in the present disclosure;

FIGS. 13 and 14 are views illustrating an operation state of the acoustic transducer illustrated in FIG. 12;

FIG. 15 is a cross-sectional view of an acoustic transducer according to another exemplary embodiment in the present disclosure;

FIG. 16 is a cross-sectional view of an acoustic transducer according to another exemplary embodiment in the present disclosure; and

FIG. 17 is a plan view of the acoustic transducer illustrated in FIG. 16.

### DETAILED DESCRIPTION

Exemplary embodiments of the present disclosure will now be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

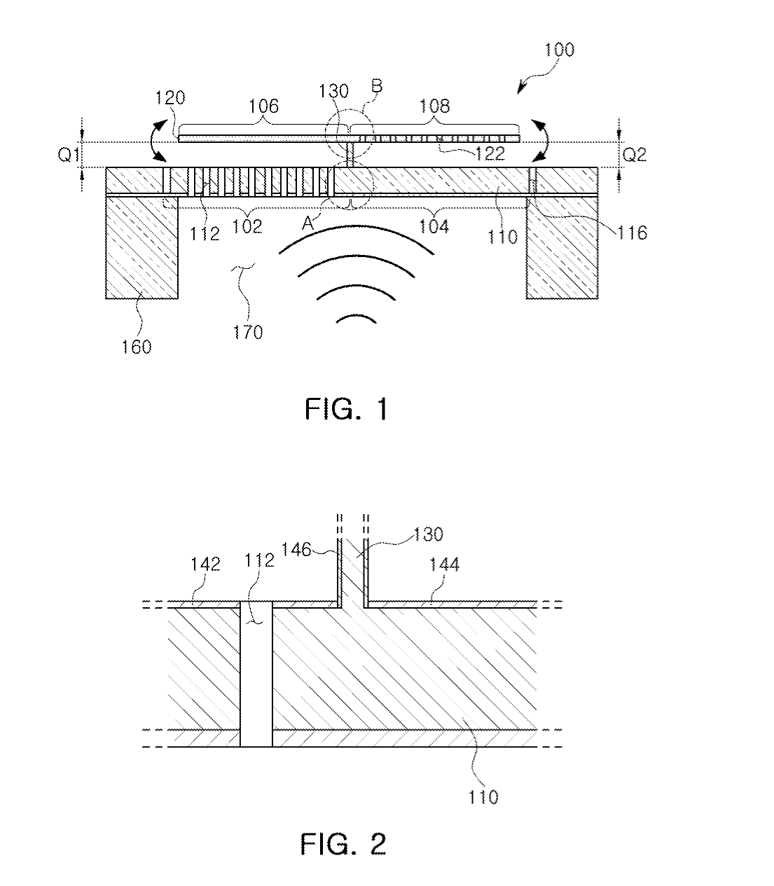

An acoustic transducer according to an exemplary embodiment in the present disclosure will be described with reference to FIG. 1.

An acoustic transducer 100 may include a substrate member 110, a vibration member 120, and a support member 130. Additionally, the acoustic transducer 100 may further include a pedestal member 160. However, the pedestal member 160 may be omitted in some cases.

The substrate member 110 may forma body of the acoustic transducer 100. However, there is no need for the substrate member 110 to be necessarily the body of the acoustic transducer 100. For example, the substrate member 110 may be a portion of a portable terminal or a small electronic device in which the acoustic transducer 100 is mounted.

The substrate member 110 may be divided into a plurality of regions. For example, the substrate member 110 may be partitioned into a first region 102 and a second region 104 based on the support member 130. The first region 102 and the second region 104 may have substantially the same size. For example, the first region 102 and the second region 104 may have a symmetrical shape based on the support member 130. The first region 102 may have a first hole 112 formed therein. For example, a plurality of first holes 102 may be formed in the first region 102 at a predetermined interval. The first hole 112 may be formed to be long along a thickness direction of the substrate member 110. Therefore, a sound wave input from the bottom (which is a reference direction of FIG. 1) of the substrate member 110 may be transferred to the top of the substrate member 110 through the first hole 112. Further, the sound wave transferred to the top of the substrate member 110 may be propagated up to the vibration member 120, to vibrate the vibration member 120.

Since the substrate member 110 which is formed as described above has the sound wave which is input only through the first region 102, it may reduce a size of a sound input chamber 170 positioned below the substrate member 110.

The substrate member 110 may have a groove 116 formed therein. For example, the groove 116 may be formed along a boundary between the first region 102 and the second region 104.

The vibration member 120 may have substantially a quadrangular shape. For example, the vibration member 120 may have a rectangular shape in which it is lengthily extended in a horizontal direction (which is a reference direction of FIG. 1) based on the support member 130. However, a cross-sectional shape of the vibration member 120 is not limited to the rectangular shape. For example, the cross-sectional shape of the vibration member 120 may be varied to a circular shape, an oval shape, or the like.

The vibration member 120 may be disposed on one side of the substrate member 110. For example, the vibration member 120 may be disposed to be spaced from the top surface (based on FIG. 1) of the substrate member 110 by a predetermined distance. The vibration member 120 may be disposed to be parallel to be the substrate member 110. For example, a distance between the substrate member 110 formed along a length direction of the vibration member 120 and the vibration member 120 may be constant.

The vibration member 120 may be divided into a plurality of regions. For example, the vibration member 120 may be partitioned into a third region 106 and a fourth region 108 based on the support member 130. The third region 106 and the fourth region 108 may have substantially the same size. For example, the third region 106 and the fourth region 108 may have a symmetrical shape based on the support member 130. The fourth region 108 may have a second hole 122 formed therein. For example, a plurality of second holes 122 may be formed in the fourth region 108 at a predetermined interval. The second hole 122 may be formed to be long along a thickness direction of the vibration member 120.

The third region 106 may be disposed to face the first region 102. For example, the third region 106 may have substantially the same size as that of the first region and may be disposed to parallel to the first region 102 (based on a state in which the vibration member 120 is stopped). The fourth region 108 may be disposed to face the second region 104. For example, the fourth region 108 may have substantially the same size as that of the second region and may be disposed to parallel to the second region 104 (based on a state in which the vibration member 120 is stopped). The fourth region 108 may have substantially the same shape as that of the first region 102. For example, the fourth region 108 may have the same size as that of the first region 102. As another example, the second hole 122 of the fourth region 108 may have the same size as that of the first hole 112 of the first region 102 and the number of second holes 122 may be the same as that of the first holes 112.

The above-mentioned configuration may allow a first area (i.e., an area except for portions in which the first holes are formed) that the first region 102 and the second region 106 substantially face each other and a second area (i.e., an area except for portions in which the second holes are formed) that the second region 104 and the fourth region 108 substantially face each other to have the same size. As another example, first capacitance Q1 formed between the first region 102 and the third region 106 may have substantially the same magnitude as that of second capacitance Q2 formed between the second region 104 and the fourth region 108 (based on a state in which the vibration member 120 is stopped). As another example, the first region 102 and the fourth region 108 may have a symmetrical shape which is rotated 180 based on the support member 130 and the second region 104 and the third region 106 may have a symmetrical shape which is rotated 180 based on the support member 130.

The fourth region 108 may have an outer size larger than that of the third region 106. As an example, a quadrangle formed along an edge of the fourth region 108 may be larger than a quadrangle formed along an edge of the third region 106. Another example, the third region 106 may have the same mass as that of the fourth region 108.

The above-mentioned configuration may advantageously allow for the vibration member 120 to maintain a horizontal balance in the state in which the vibration member 120 is stopped. However, if a difference in mass between the third region 106 and the fourth region 108 is not large, the above-mentioned configuration may be omitted.

The support member 130 may be formed between the substrate member 110 and the vibration member 120. For example, the support member 130 may be extended to be long from a boundary point between the first region 102 and the second region 104 to a boundary point between the third region 106 and the fourth region 108. The support member 130 may have a significant magnitude of elastic force. For example, the support member 130 may have magnitude of the elastic force capable of restoring the vibration member 120 rotated or inclined in one direction to an original position. The support member 130 configured as described above may allow a rotation movement of the vibration member 120. For example, the vibration member 120 may be rotated in a clockwise direction or a counter clockwise direction based on the supports member 130. As an example, the vibration member 120 may be rotated in the clockwise direction by the sound wave introduced through the first hole 112, and may be then rotated in the counter clockwise direction by restoring force. In addition, the vibration member 120 may repeat the rotation movement in the clockwise direction and the rotation movement in the counter clockwise direction described above according to magnitude and kind of the sound wave during a predetermined time.

The pedestal member 160 may be formed on one side of the substrate member 110. For example, the pedestal member 160 may be formed to maintain the substrate member 110 at a predetermined height. However, there is no need to necessarily form the pedestal member 160 on one side of the substrate member 110. For example, the pedestal member 160 may be formed on a terminal apparatus having the acoustic transducer 100 mounted therein.

The sound input chamber 170 may be formed below the substrate member 110. For example, the sound input chamber 170 may be a space formed by the substrate member 110 and the pedestal member 160. The sound input chamber 170 may temporarily store the sound input from the outside. For example, the sound input chamber 170 may form a back volume or a front volume required for sensing the sound.

Next, cross-sectional structures of the substrate 110 and the support member 130 will be described with reference to FIG. 2.

The substrate member 110 may have an electrode formed thereon. For example, the substrate member 110 may have one or more electrodes formed on a top surface thereof. As an example, the first region 102 of the substrate member 110 may have a first electrode 142 formed thereon and the second region 104 of the substrate member 110 may have a second electrode 144 formed thereon. The first electrode 142 and the second electrode 144 may have the same polarity or different polarities. However, the first electrode 142 and the second electrode 144 may not be connected to each other on the substrate member 110. That is, the first electrode 142 may be connected to a first output circuit and the second electrode 144 may be connected to a second output circuit.

The support member 130 may have an electrode 146 formed thereon. For example, the support member 130 may have a third electrode 146 formed thereon. The third electrode 146 may have polarity different from that of the first electrode 142 and the second electrode 144.

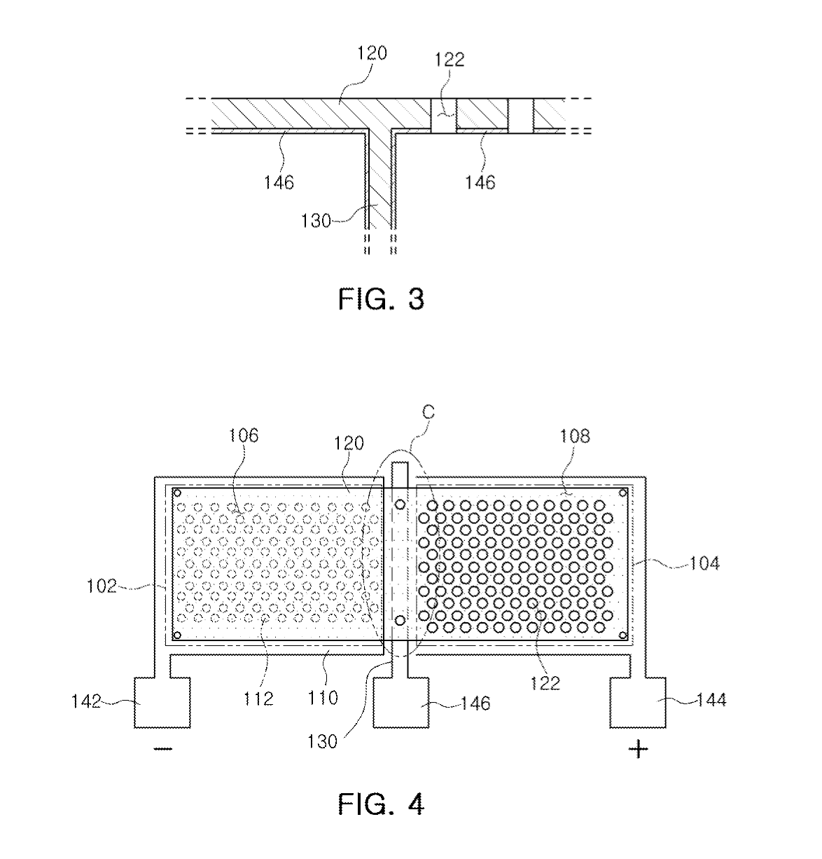

Next, a cross-sectional structure of the vibration member 120 will be described with reference to FIG. 3.

The vibration member 120 may have an electrode formed thereon. For example, the vibration member 120 may have the third electrode 146 formed on a bottom surface thereof. The third electrode 146 may be extended to be long along the support member 130. For example, the third electrode 146 may be formed to be wide along the bottom surface of the vibration member 120 and may be then formed to be extended to a downward direction along the support member 130. The third electrode 146 may have polarity different from that of the first electrode 142 and the second electrode 144.

Next, a plan structure of the acoustic transducer 100 will be described with reference to FIG. 4.

The acoustic transducer 100 may have a plurality of regions formed to be symmetrical with each other based on the support member 130. For example, the first region 102 and the third region 106 may be disposed at the left (which is a direction based on FIG. 4) of the support member 130, and the second region 104 and the fourth region 108 may be disposed at the right of the support member 130.

The acoustic transducer 100 may have a plurality of capacitances formed to be symmetrical with each other based on the support member 130. For example, the first region 102 and the third region 106 may have first capacitance formed therebetween, and the second region 104 and the fourth region 108 may have second capacitance therebetween. For reference, the first capacitance may be measured by the first output circuit that connects the first electrode 142 and the third electrode 146 to each other and the second capacitance may be measured by the second output circuit that connects the second electrode 144 and the third electrode 146 to each other. The first capacitance and the second capacitance may have the same magnitude in a state in which the vibration member 120 is stopped.

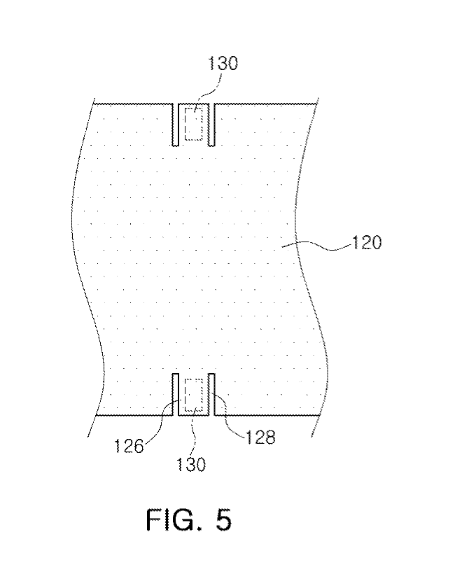

Next, a connection form of the vibration member 120 and the support member 130 will be described with reference to FIG. 5.

The vibration member 120 may be connected to the support member 130 to be rotatable. For example, the vibration member 120 may have a connection part 126 extended to a width direction and may be connected to the support member 120 by the connection part 126. The connection part 126 may be formed by cutting grooves 128. For example, both sides of the connection part 126 may be separated from other portions of the vibration member 120 by the cutting grooves 128. This structure may allow the vibration member 120 to be rotated even in a state in which the connection part 126 and the support member 130 are coupled to each other.

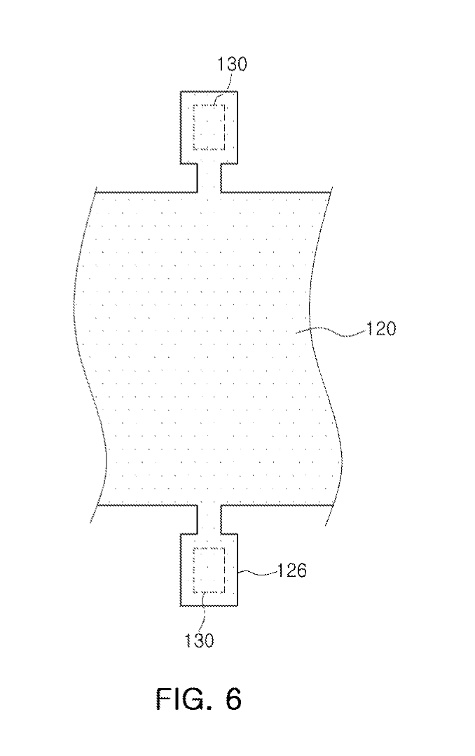

Next, another connection form of the vibration member 120 and the support member 130 will be described with reference to FIG. 6.

The vibration member 120 may have connection parts 126 that protrude to the outside. For example, a pair of connection parts 126 that protrude to side directions of the vibration member 120 may be formed at both sides of the vibration member 120. The two connection parts 126 may be connected to the same number of support members 130.

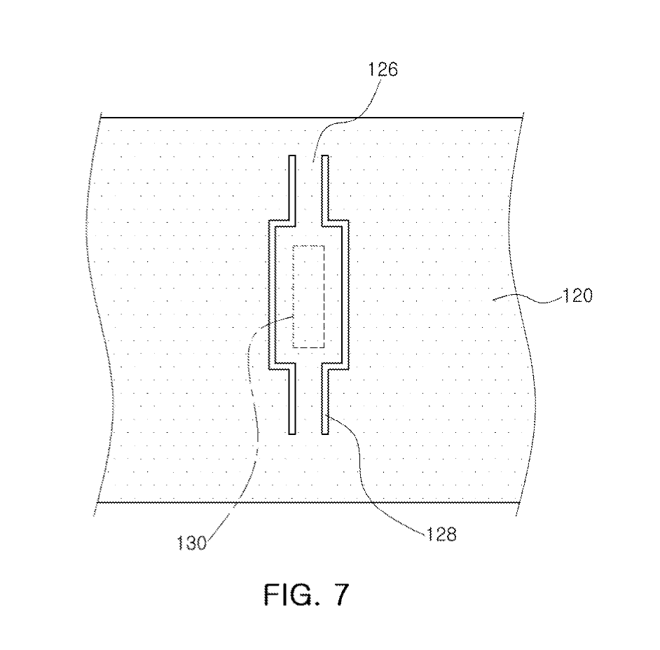

Next, another connection form of the vibration member 120 and the support member 130 will be described with reference to FIG. 7.

The vibration member 120 may have one connection part 126. For example, one connection part 126 may be formed by a plurality of cutting grooves 128 that partition the vibration member 120 into three spaces. One connection part 126 may be connected to one or more support members 130.

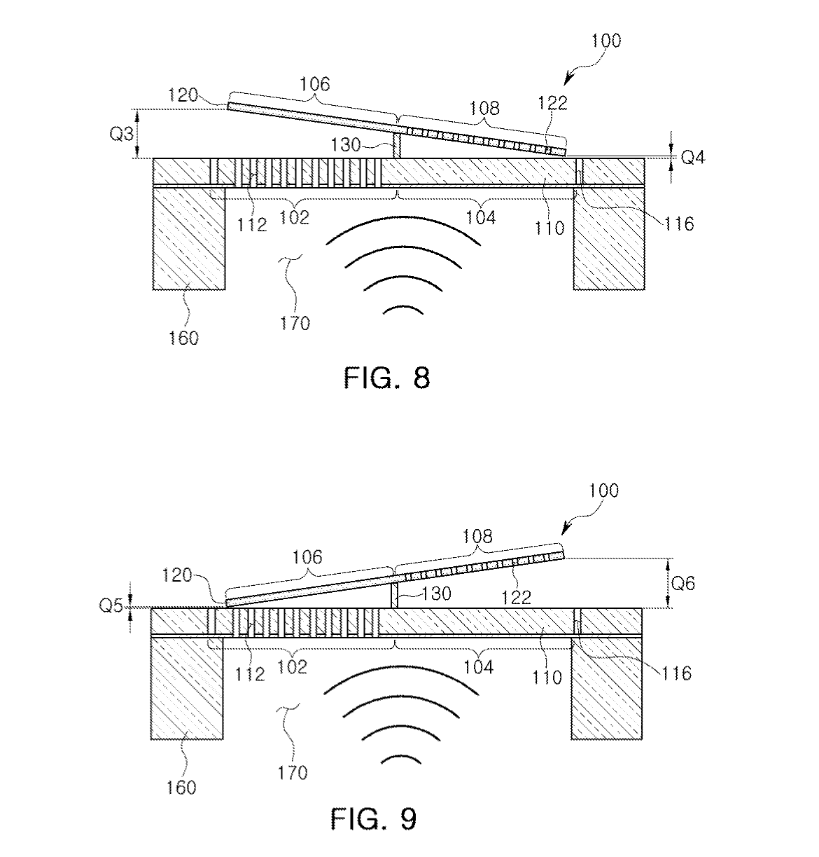

Next, an operation state of the acoustic transducer 100 according to an exemplary embodiment in the present disclosure will be described with reference to FIGS. 8 and 9.

The acoustic transducer 100 may measure capacitance generated according to the rotation movement of the vibration member 120. As an example, the acoustic transducer 100 may measure third capacitance Q3 and fourth capacitance Q4 generated as the vibration member 120 is rotated in a state illustrated in FIG. 8. As another example, the acoustic transducer 100 may measure fifth capacitance Q5 and sixth capacitance Q6 generated as the vibration member 120 is rotated in a state illustrated in FIG. 9.

The acoustic transducer 100 may sense the sound wave through a change amount in capacitance. As an example, the acoustic transducer 100 may sense the sound wave through deviation between the capacitances Q1 and Q2 measured in a state in which the vibration member 120 is stopped and the capacitances Q3 and Q4, or Q5 and Q6 measured in a state in which the vibration member 120 is rotated.

The acoustic transducer 100 as described above may decrease a signal to noise ratio.

As an example, a case in which the vibration member 120 is transformed from the stop state of FIG. 1 to the rotation state of FIG. 8 will be described. In this case, capacitance between the first region 102 and the third region 106 may be decreased as compared to the first capacitance Q1 in the stop state, and capacitance between the second region 104 and the fourth region 108 may be increased as compared to the second capacitance Q2 in the stop state. Consequently, a change amount in the first capacitance between the first region 102 and the third region 106 may be expressed by the following Equation 1 and a change amount in the second capacitance between the second region 104 and the fourth region 108 may be expressed by the following Equation 2.

Changed Amount in First Capacitance=Q1−(Q3+ΔNQ1) (Equation 1)

Changed Amount in Second Capacitance=(Q4+ΔNQ2)−Q2 (Equation 2)

In the Equations 1 and 2, ΔNQ1 and ΔNQ2 illustrate capacitances generated by noise components.

Here, it is understood that since a rotation amount of the vibration member 120 is the same in either the first region 102 or the second region 104, the vibration member 120 has magnitudes of ΔNQ1 and ΔNQ2 depending on the rotation of the vibration member 120. Further, since the first capacitance Q1 and the second capacitance Q2 are values measured in the state in which the vibration member 120 is stopped, they may have the same magnitude. Therefore, since a capacitance value (Q4−Q3) from which the components of ΔNQ1 and ΔNQ2 are removed may be obtained by summing the change amount in the first capacitance and the change amount in the second capacitance, the signal to noise ratio may be decreased.

As another example, a case in which the vibration member 120 is transformed from the stop state of FIG. 1 to the rotation state of FIG. 9 will be described. In this case, the capacitance between the first region 102 and the third region 106 may be increased as compared to the first capacitance Q1 in the stop state, and the capacitance between the second region 104 and the fourth region 108 may be decreased as compared to the second capacitance Q2 in the stop state. Consequently, a change amount in the third capacitance between the first region 102 and the third region 106 may be expressed by the following Equation 3 and a change amount in the fourth capacitance between the second region 104 and the fourth region 108 may be expressed by the following Equation 4.

Changed Amount in Third Capacitance=(Q5+ΔNQ3)−Q1 (Equation 3)

Changed Amount in Fourth Capacitance=Q2−(Q6+ΔNQ4) (Equation 4)

In the Equations 3 and 4, ΔNQ3 and ΔNQ4 illustrate capacitances generated by noise components.

Here, it is understood that since the rotation amount of the vibration member 120 is the same in either the first region 102 or the second region 104, the vibration member 120 has magnitudes of ΔNQ3 and ΔNQ4 depending on the rotation of the vibration member 120. Further, since the third capacitance Q3 and the fourth capacitance Q4 are values measured in the state in which the vibration member 120 is stopped, they may have the same magnitude. Therefore, a capacitance value (Q5−Q6) from which the noise components ΔNQ3 and ΔNQ4 are removed may be obtained by summing the change amount in the third capacitance and the change amount in the fourth capacitance, similar to the example as describe above.

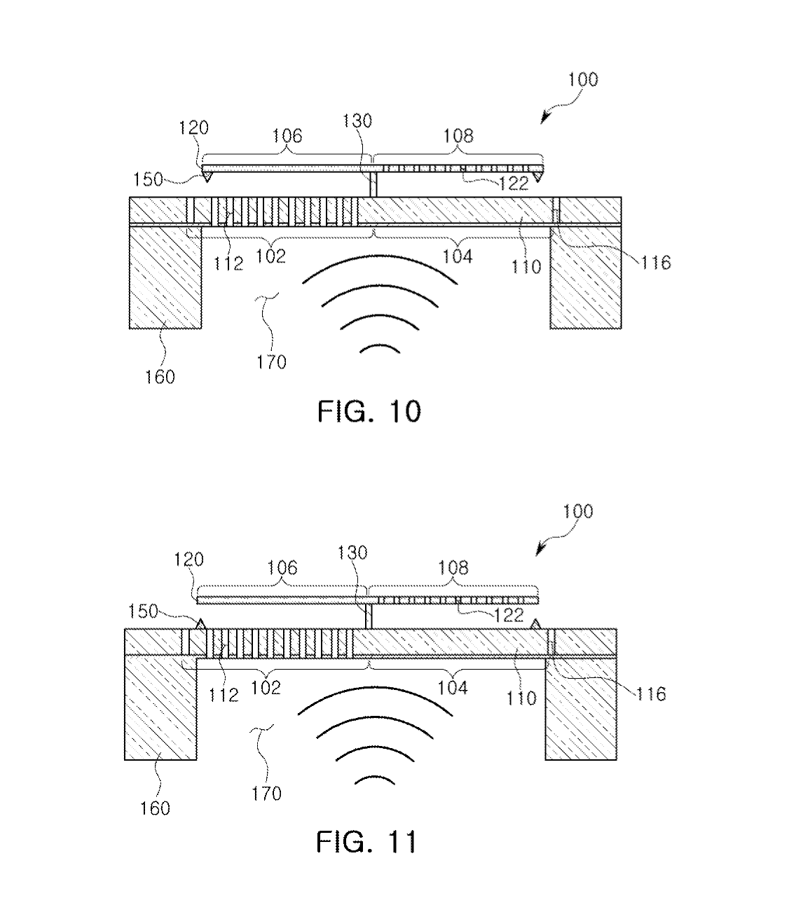

Next, an acoustic transducer according to another exemplary embodiment in the present disclosure will be described with reference to FIGS. 10 and 11.

The acoustic transducer 100 according to the present exemplary embodiment may further include insulating members 150. As an example, the insulating members 150 may be formed at both ends of the vibration member 120 as illustrated in FIG. 10. As another example, the insulating members 150 may be formed on the substrate member 110 as illustrated in FIG. 11.

The insulating members 150 configured as described above may block a contact between the substrate member 110 and the vibration member 120. Therefore, according to the present exemplary embodiment, a problem caused due to electrical contact between the substrate member 110 and the vibration member 120 may be solved.

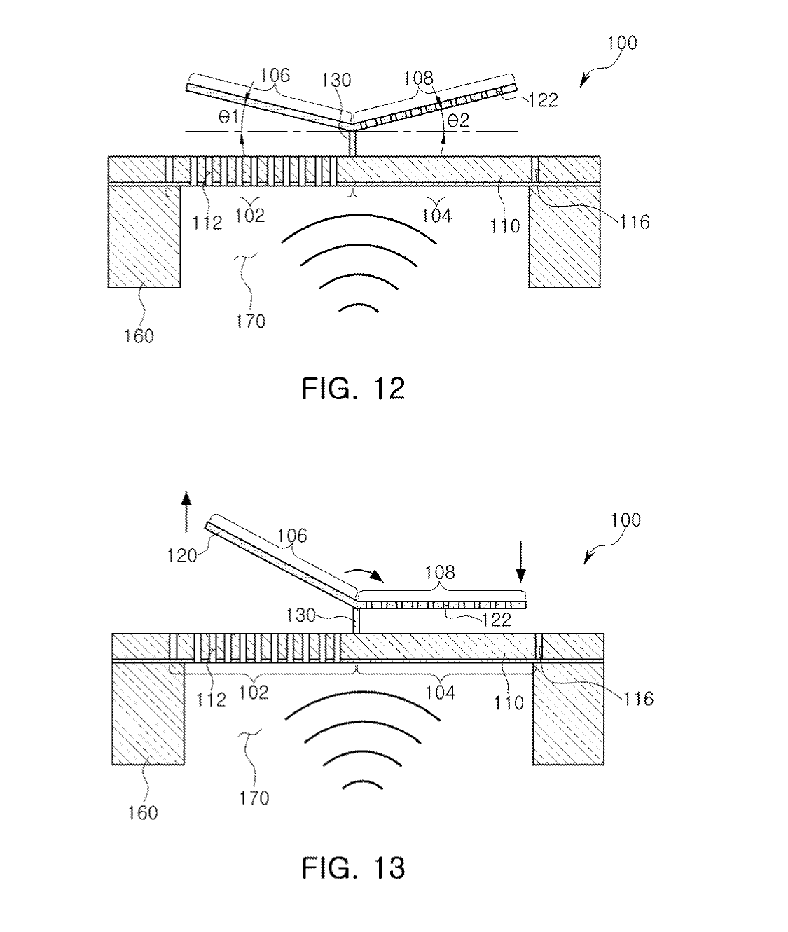

Next, an acoustic transducer according to another exemplary embodiment in the present disclosure will be described with reference to FIG. 12.

The acoustic transducer 100 according to the present exemplary embodiment may be distinguished from the acoustic transducer 100 according to an exemplary embodiment as described above in the shape of the vibration member 120. As an example, the vibration member 120 may have a bent shape to each have inclines of a first angle θ1 and a second angle θ2 for one surface of the substrate member 110.

The first angle θ1 and the second angle θ2 may have the same value as each other in the state in which the vibration member 120 is stopped. For example, the vibration member 120 in the stop state may have a bilaterally symmetrical shape based on the support member 130.

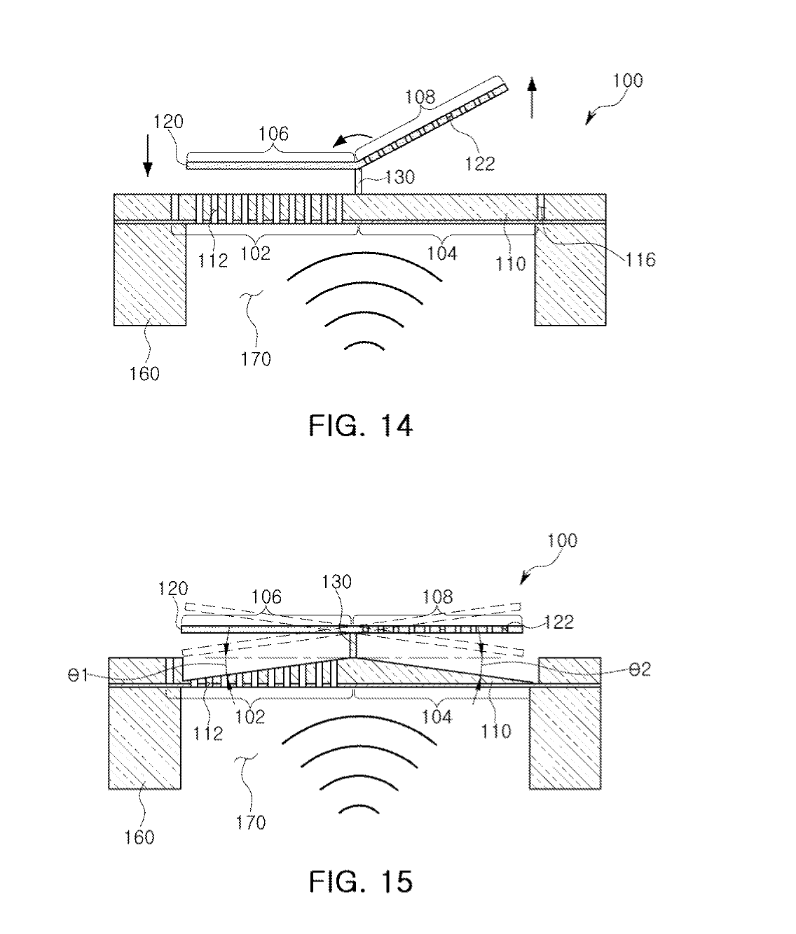

Next, an operation state of an acoustic transducer according to another exemplary embodiment in the present disclosure will be described with reference to FIGS. 13 and 14.

The acoustic transducer 100 according to the present exemplary embodiment may be configured so that the first region 102 and the third region 106 or the second region 104 and the fourth region 108 face each other to be parallel to each other in the state in which the vibration member 120 is rotated.

As an example, in the case in which the vibration member 120 is rotated in the clockwise direction as illustrated in FIG. 13, the second region 104 and the fourth region 108 may be disposed to face each other to be parallel to each other. As another example, in the case in which the vibration member 120 is rotated in the counter clockwise direction as illustrated in FIG. 14, the first region 102 and the third region 106 may be disposed to face each other to be parallel to each other.

The acoustic transducer 100 configured as described above may significantly increase the change amount in the capacitance between the first region 102 and the third region 106, and the second region 104 and the fourth region 108.

Next, an acoustic transducer according to another exemplary embodiment in the present disclosure will be described with reference to FIG. 15.

The acoustic transducer 100 according to the present exemplary embodiment may be distinguished from the acoustic transducer 100 according to the exemplary embodiments as described above that the substrate member 110 has an inclined surface formed thereon. For example, the first region 102 of the substrate member 110 may be formed to have an incline of the first angle θ1 for the third region 106 of the vibration member 120 and the second region 104 of the substrate member 110 may be formed to have an incline of the second angle θ2 for the fourth region 108 of the vibration member 120.

The acoustic transducer 100 configured as described above may significantly increase the change amount in the capacitance between the first region 102 and the third region 106, and the second region 104 and the fourth region 108, similar to the exemplary embodiment as described above.

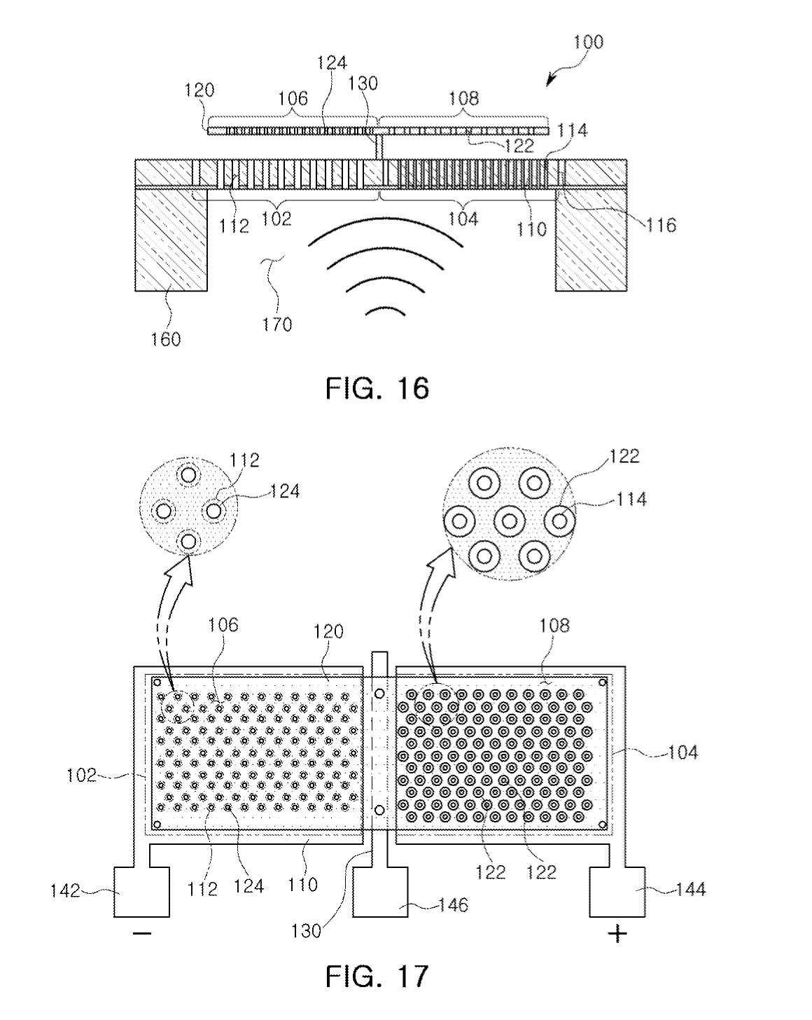

Next, an acoustic transducer according to another exemplary embodiment in the present disclosure will be described with reference to FIGS. 16 and 17.

The acoustic transducer 100 according to the present exemplary embodiment may be distinguished from the acoustic transducer 100 according to the exemplary embodiments as described above that the second region 104 and the third region 106 have fine holes 114 and 124 formed therein.

As an example, the second region 104 may have first fine holes 114 formed therein and the third region 106 may have second fine holes formed therein. The fine holes 114 and 124 may be formed to have sizes smaller than those of the holes 112 and 122. For example, the first fine hole 114 may have the size smaller than that of the first hole 112 and the second fine hole 124 may have the size smaller than that of the second hole 122. The fine holes 114 and 124 may be formed to face the holes 112 and 122. For example, the first fine holes 114 may be formed to face the second holes 122 and the second fine holes 124 may be formed to face the first holes 112. The fine holes 114 and 124 may be formed to have the same number as that of the holes 112 and 122. As an example, the first fine holes 114 may be formed to have the same number as that of second holes 122 and the second fine holes 124 may be formed to have the same number as that of first holes 112. However, the fine holes 114 and 124 may not be necessarily formed to have the same number as that of holes 112 and 122. As an example, the fine holes 114 and 124 may be formed to have the number smaller than that of the holes 112 and 122.

Since the acoustic transducer 100 configured as described above has the holes formed in all of the first region 102 and the second region 104 of the substrate member 110, the vibration member 120 may be easily rotated by the sound wave. Therefore, the present acoustic transducer 100 may improve measurement sensitivity of the sound wave.

As set forth above, according to exemplary embodiments of the present disclosure, the signal to noise ratio may be effectively decreased.

While exemplary embodiments have been shown and described above, it will be apparent to those skilled in the art that modifications and variations could be made without departing from the scope of the present invention as defined by the appended claims.

What is claimed is:

1. An acoustic transducer, comprising:
a substrate member including a first region having one or more first holes formed in the first region, and a second region;
a vibration member including a third region facing the first region and a fourth region facing the second region and having one or more second holes formed in the fourth region; and
a support member extended from a boundary region between the first region and the second region to a boundary region between the third region and the fourth region, to allow the substrate member and the vibration member to be spaced apart from each other by a predetermined interval.

2. The acoustic transducer of claim 1, further comprising electrodes respectively disposed on the substrate member and the vibration member.

3. The acoustic transducer of claim 1, further comprising:
a first electrode formed on the first region;
a second electrode formed on the second region; and
third electrodes formed on the third region and the fourth region.

4. The acoustic transducer of claim 1, wherein the first hole and the second hole are formed to have an equal amount.

5. The acoustic transducer of claim 1, wherein an area in which the first region faces the third region has the same size as an area in which the fourth region faces the second region.

6. The acoustic transducer of claim 1, wherein the first region has an outer size larger than an outer size of the second region, and
the fourth region has an outer size larger than an outer size of the third region.

7. The acoustic transducer of claim 1, wherein the vibration member includes a connection part connected to the support member.

8. The acoustic transducer of claim 1, wherein the substrate member has grooves formed along edges of the first region and the second region.

9. The acoustic transducer of claim 1, wherein the substrate member or the vibration member is provided with an insulating member configured to prevent electrical contact between the substrate member and the vibration member.

10. The acoustic transducer of claim 1, wherein the vibration member has both ends extended in a direction away from the substrate member, based on the support member.

11. The acoustic transducer of claim 1, wherein the substrate member has an incline to be apart from the vibration member, based on the support member.

12. An acoustic transducer, comprising:
a substrate member including a first region having one or more first holes formed in the first region and a second region in which first fine holes smaller than the first holes are formed;
a vibration member including a third region facing the first region and having second fine holes smaller than the first holes, formed in the third region, and a fourth region facing the second region and having one or more second holes formed in the fourth region; and
a support member extended from a boundary region between the first region and the second region to a boundary region between the third region and the fourth region, to allow the substrate member and the vibration member to be spaced apart from each other by a predetermined interval.

13. The acoustic transducer of claim 12, wherein the first fine holes are disposed to face the second holes, and
the second fine holes are disposed to face the first holes.

14. The acoustic transducer of claim 12, wherein the first fine holes and the second fine holes are formed to have an equal amount.

15. The acoustic transducer of claim 12, wherein the second region and the third region have the same area as each other.
